(19) United States
(12) Patent Application Publication
(10) Pub. No.: US 2005/0250466 A1
(43) Pub. Date: Nov. 10, 2005

(54) Method and apparatus for improving MLSE in the presence of co-channel interferer for GSM/GPRS systems

(75) Inventors: Gottimukkala Narendra Varma, Andhra Pradesh (IN); Kunwar Devesh, Andhra Pradesh (IN); Chitrala Srinivasulu, Andhra Pradesh (IN)

Correspondence Address: William L. Botjer, PO Box 478, Center Moriches, NY, 11934, US

(73) Assignee: HELLOSOFT INC., SAN JOSE, CA (US)

(21) Appl. No.: 10/833,441

(22) Filed: Apr. 26, 2004

(51) Int. Cl. H04B 1/10

(52) U.S. Cl. 455/296; 375/231

(57) ABSTRACT

A method and an apparatus for improving the equalization performance of a wireless receiver in the presence of co-channel interference by selectively filtering a received signal are disclosed. In the presence of co-channel interference, the noise in the received signal comprises a white noise component and a non-white noise component. Improvement in equalization is achieved by whitening the non-white noise component by selectively filtering the received signal. The selective filtering is governed by the dominant component of the noise in the received signal. The disclosed invention is suitable for use in Global System for Mobile Communications (GSM) wireless receivers using Gaussian Minimum Shift Keying (GMSK) signaling. The non-white noise component in the received signal, caused predominantly by co-channel interference, is whitened before feeding the received signal to Maximum Likelihood Sequence Estimator (MLSE), thereby improving the performance of MLSE.

### BACKGROUND

The present invention relates to receivers used in wireless communication, and more particularly to mitigate the effects of co-channel interference by selectively filtering the received signal in wireless receivers.

The use of wireless communication services is continuously growing. New wireless systems, offering a plurality of services, are currently deployed in rapidly increasing numbers. These wireless systems offer a wide variety of services including radio and television broadcasts, mobile telephony, point-to-point communication, wireless data traffic, etc, ranging from large cellular networks to small stand-alone systems.

However, all these wireless systems share a common propagation medium over which they operate. Further, the propagation medium has a limited radio frequency spectrum suitable for wireless transmissions. A large growth in demand for wireless services over the last few decades has made the radio frequency spectrum very crowded, leading to a scarcity of communication bandwidth.

A solution for effectively handling the scarcity of bandwidth is to reuse the radio frequency spectrum in a wireless service area. This is achieved by dividing the wireless service area into smaller areas, or cells, and reusing the radio frequencies in geographically disjoint cells. Such an implementation supports multiple users at the same transmission frequency. However, it also leads to interference between two transmissions at the same frequency. Such interference is called co-channel interference. Further, transmission over wireless channels is also susceptible to signal distortion and impairment by noise. Consequently, special measures implemented in the wireless receiver are necessary to recover the transmitted data from the received signal. This requires an equalization method to be applied to the received signal.

A technique for equalization of wireless channel signals is the maximum likelihood sequence estimation (MLSE) technique, which is described in G. D. Forney's journal, “Maximum-Likelihood Sequence Estimation of Digital Sequences in the Presence of Intersymbol Interference”, IEEE transactions on Information Theory, IT-18, 363-378, May 1972. This technique can be implemented using the Viterbi algorithm. However, this equalization technique performs optimally when the received signal is impaired only by additive white Gaussian noise (AWGN). Herein, white noise is a random noise that contains an equal amount of energy per frequency band. This technique degrades severely in the presence of co-channel interference that is neither white nor Gaussian in nature. Noise containing unequal amount of energy per frequency band is hereinafter referred to as non-white noise.

One of the popular approaches to tackle the problem of co-channel interference is through the use of joint detection techniques. These techniques involve simultaneous detection of the desired signal and the co-channel interferer noise. Most joint detection techniques are based on the MLSE principle. K. Giridhar et. al in “Joint Estimation Algorithm For Co-Channel Signal Demodulation”, IEEE international conference on communication (ICC), Geneva, 1993, And “Joint Demodulation Of Co-Channel Signals Using MLSE And MAPSD Algorithms”, IEEE ICC, Philadelphia, Pa., June 1988, proposed an MLSE based approach to cancel the interferer noise assuming known channel conditions and static intersymbol interference (ISI). Further, Giridhar et. al proposed an algorithm for the joint estimation of co-channel signal in “Nonlinear Techniques For The Joint Estimation Of Co-Channel Signals”, IEEE transaction on Communication, vol. 45, no. 4, April 1997. They utilized the maximum likelihood (ML) and maximum a posterior (MAP) criteria, assuming a finite impulse response channel. They also derived an algorithm for a priori unknown channels. W. Van Etten, “Maximum-Likelihood Receiver For Multiple Channel Transmission Systems”, IEEE transaction on Communications, February 1976, has extended the viterbi algorithm for detecting multiple co-channel interference signals. Their approach is known as the vector viterbi algorithm.

Publications by Peter A. Murphy and Gary E. Ford, “Co-Channel Demodulation For Continuous Phase Modulation Signals”, Department of Electrical and Computer Engineering, University of California, Davis, Calif., and P. A. Ratna, A. Hottinen, and Z. Honkasalo, “Co-channel Interference Canceling Receiver for TDMA Mobile Systems”, IEEE ICC, 1995, have also proposed a joint MLSE based method for joint detection of two narrowband, co-channel Gaussian minimum shift keying (GMSK) signals.

Further, a single-input co-channel signal separation technique in ISI-free channels for angle-modulated signals has been proposed by Y. Bar-Ness and H. Bunin in “Co-Channel Interference Suppression And Signal Separation Method”, IEEE ICC, Philadelphia, Pa., June 1988. Bar-Ness et. al. also proposed a method for co-channel interference suppression of an angle-modulated signal by estimating the parasitic phase distortion incurred by the interferer, which can be calculated by analyzing the amplitude variation of the composite signal.

In addition to the above publications, U.S. Pat. No. 6,314,147, titled “Two-stage CCI/ISI Reduction With Space-Time Processing in TDMA Cellular Networks”, assigned to The Board of Trustees of the Leland Stanford Junior University, Stanford, Calif., provides a two-stage space-time receiver with improved estimates of data symbols from a received signal comprising the data symbols, co-channel interferer noise and intersymbol interference. The method described in this patent does not identify the nature of interference. In this method, each incoming signal is passed though a linear filter whose coefficients are dynamically calculated. These calculations lead to high computational complexity of the system.

Most existing techniques are based on the joint detection of the desired and the co-channel interferer signals. These techniques require frame synchronization of the received signal at the receiver, as the transmitted signal passes though various channels on its way to the receiver. The techniques also involve joint channel estimation of the desired and the co-channel interferer signals, and joint MLSE equalization of the two signals. Therefore, separate calculations for the desired signal and the co-channel interferer signal need to be carried out by the MLSE, and separate channel estimation needs to be performed for these two signals, thereby increasing the computational complexity of the receiver. Execution of these computationally complex techniques requires extra processing power and memory, along with additional power supply to support the increased computational complexity. However, the processing power available in existing GSM receivers is not sufficient to support these algorithms. The existing receivers require upgrading of existing hardware platforms with hardware acceleration and high memory speeds.

Therefore, there is a need of a computationally simple solution for improving the performance of MLSE based receivers by suppressing the negative effects of co-channel interferer noise. The solution should be able to improve the performance of the receiver by minimal changes in the hardware platform. Further, the solution should be portable on existing hardware platforms.

### SUMMARY

An objective of the present invention is to improve equalization in a wireless receiver in the presence of co-channel interference.

Another objective of the present invention is to provide a computationally simple solution to improve equalization in a wireless receiver in the presence of co-channel interference.

Yet another objective of the present invention is to provide a computationally simple solution to whiten non-white noise components in a received signal.

A further objective of the present invention is to provide a solution for improving equalization that is implemented within the computational capacity of existing wireless receiver architectures.

In order to achieve the above-mentioned objectives, the present invention provides a method and an apparatus for improving equalization in a wireless receiver in the presence of co-channel interference. Co-channel interference introduces a significant component of non-white noise in the received signal. Additionally, the received signal contains Additive White Gaussian Noise (AWGN) introduced by the thermal effects in the wireless receiver. Therefore, the noise in the received signal comprises a white noise component and a non-white noise component. However, most of the conventional equalizers used in wireless receivers, such as MLSE, assume that the noise present in the received signal is predominantly white. The non-white noise component violates this assumption and hence degrades the equalization performance at the wireless receiver. The disclosed method avoids this degradation by selectively filtering the received signal before feeding the received signal to the equalizer. The selective filtering is performed to whiten the non-white noise component, if a significant non-white noise component is detected in the received signal. The selective filtering of the received signal is performed by first determining the dominating noise component in the received signal. If the non-white noise component dominates, the received signal is passed through a pre-filter to generate the selectively filtered signal. However, if the white noise component dominates, the received signal is selected as the selectively filtered signal. The selectively filtered signal is fed to an equalizer that generates the decoded sequence.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a flow chart depicting a method of improving equalization in a wireless receiver in accordance with an embodiment of the disclosed invention;

FIG. 2 is a graph showing the autocorrelation function for a GMSK signal and an Additive White Gaussian Noise (AWGN) signal;

FIG. 3 is a flow chart depicting a method of determining the dominant noise component in a received signal in accordance with an embodiment of the disclosed invention;

FIG. 4 is a block diagram depicting an apparatus for improving equalization in a wireless receiver in accordance with an embodiment of the disclosed invention; and

FIG. 5 is a block diagram depicting a logic block in accordance with an embodiment of the disclosed invention.

### DESCRIPTION OF PREFERRED EMBODIMENTS

The disclosed invention provides a method and an apparatus to improve equalization in a wireless receiver by selectively filtering a received signal r(n). Received signal r(n) comprises a desired signal and noise. The desired signal comprises a training sequence Iₜᵣ(n) that is known to the wireless receiver. Received signal r(n) is used to obtain a first channel estimate h₁ by using training sequence Iₜᵣ(n) in the wireless receiver. The noise comprises a white noise component and a non-white noise component. The disclosed invention achieves the improvement by whitening the non-white noise component in received signal r(n). An example of the non-white noise component is the co-channel interference experienced in GMSK modulation used in GSM communication.

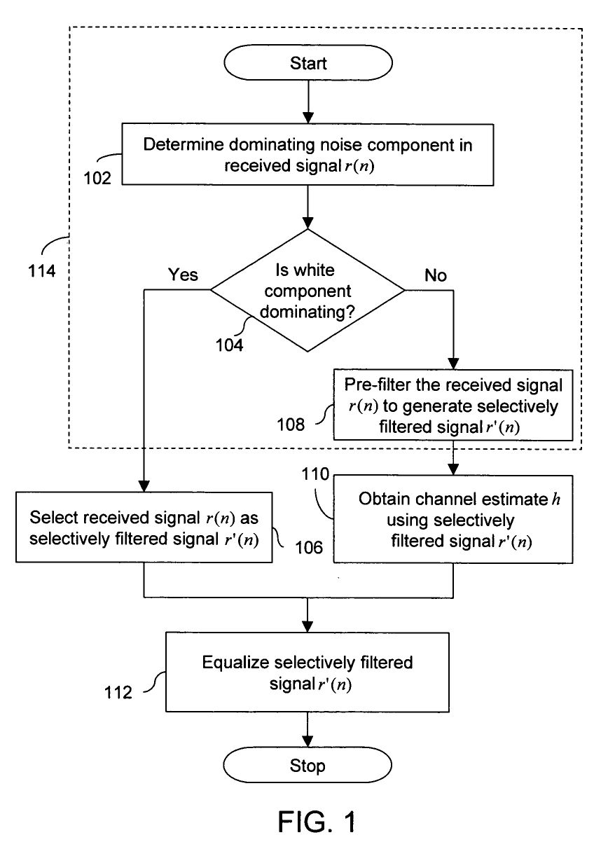

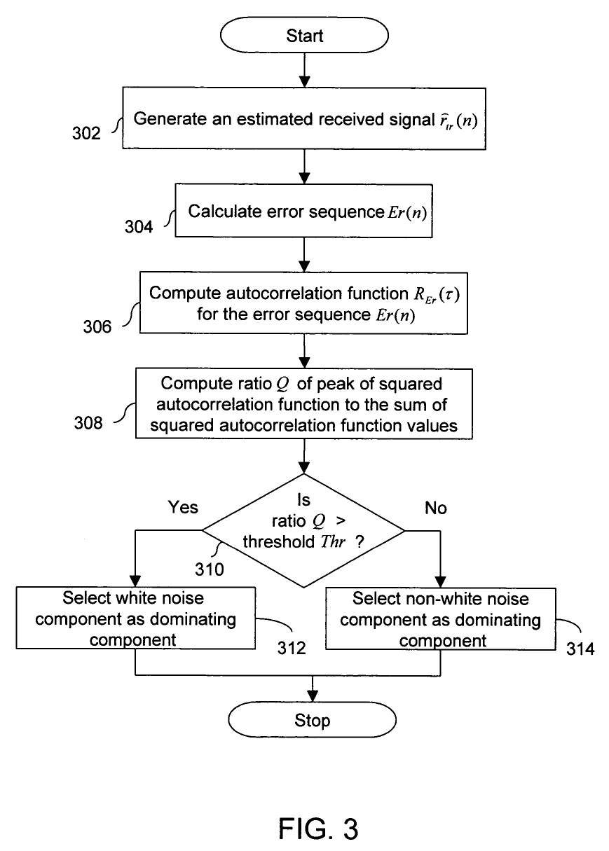

Referring to FIG. 1, a method of improving equalization in a wireless receiver in accordance with an embodiment of the disclosed invention is hereinafter described. At step 102, received signal r(n) is analyzed to determine a dominant noise component. The various steps involved in determining the dominant noise component in the received signal will be explained in detail in conjunction with FIG. 3. After step 102, a check is made on the dominant noise component at step 104. If the white noise component dominates, received signal r(n) is selected as a selectively filtered signal r′(n) at step 106. On the other hand, if the non-white noise component dominates, received signal r(n) is pre-filtered to generate a selectively filtered signal r′(n) at step 108. The step of pre-filtering involves whitening the non-white noise component. Selectively filtered signal r′(n) has the white noise component as the dominant noise component. At step 110, channel estimation of selectively filtered signal r′(n) is performed to obtain a second channel estimate h₂ using training sequence Iₜᵣ(n). Second channel estimate h₂is used to capture the pre-filtering effect on received signal r(n). At step 112, selectively filtered signal r′(n), using a channel estimate h, is equalized to produce a decoded sequence. First channel estimate h₁ is selected as channel estimate h if the white noise component dominates. On the other hand, second channel estimate h₂ is selected as channel estimate h if non-white noise component dominates.

Further, a portion 114 shown in FIG. 1, comprising steps 102, 104 and 108, depicts a method of whitening a received signal comprising a non-white noise component, in accordance with an embodiment of the disclosed invention. In an exemplary embodiment, the wireless receiver is a Gaussian Minimum Shift Keying (GMSK) receiver.

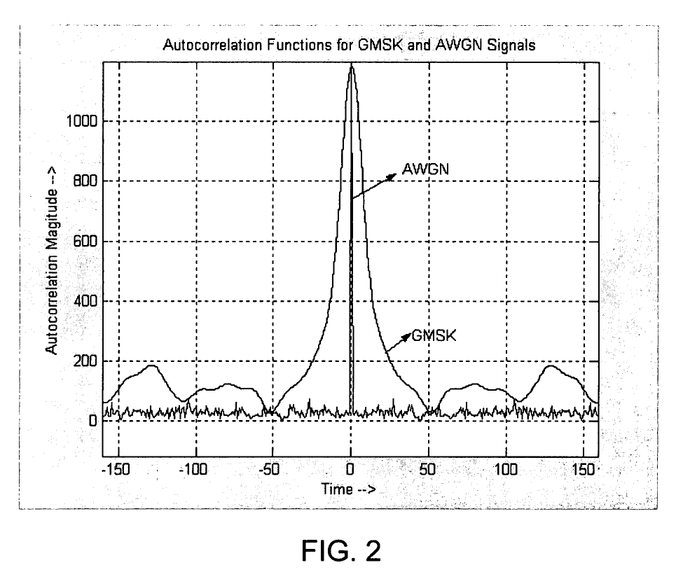

According to the disclosed invention, the dominant noise component is determined using the contrast in the autocorrelation properties of white noise and non-white noise. Referring primarily to FIG. 2, a graph showing the autocorrelation function for a GMSK signal and an Additive White Gaussian Noise (AWGN) signal is hereinafter described. In the case of co-channel interference, the non-white noise component comprises primarily a GMSK signal, while the white noise component is caused by an AWGN signal. As seen in FIG. 2, the ratio of the squared autocorrelation peak to the sum of the squared autocorrelation values is less for the GMSK signal and more for the AWGN signal. Therefore, in a mixed signal comprising both the white noise component and the non-white noise component, this ratio is used to determine the dominant noise component of the mixed signal. The related method is now explained with reference to FIG. 3.

Referring primarily to FIG. 3, a method of determining the dominant noise component in a received signal is hereinafter described. This method uses training sequence Iₜᵣ(n), which is present in the desired signal. At step 302, estimated received signal \hat{r}ₜᵣ(n), corresponding to training sequence Iₜᵣ(n), is generated using training sequence Iₜᵣ(n) and an estimate of channel impulse response ĥ(n). Step 302 is represented mathematically as:
\hat{r}ₜᵣ(n)=ĥ(n)*Iₜᵣ(n) (1)
where * denotes convolution. At step 304, error sequence Er(n) is calculated by subtracting estimated received signal \hat{r}ₜᵣ(n) from received training signal rₜᵣ(n):
Er(n)=rₜᵣ(n)−\hat{r}ₜᵣ(n) (2)

Autocorrelation function R_{Er}(τ) of error sequence Er(n) is calculated at step 306 using the following relation:
R_{Er}(τ)=E(Er(n)·Er(n+τ)) (3)
where E( ) denotes an expectation operator. At step 308 ratio Q of peak of squared autocorrelation function R_{Er}(τ) to the sum of squared autocorrelation function R_{Er}(τ) values is calculated. This is mathematically represented as:

$$Q = {R}_{Er}^{2} ( 0 ) / {\sum }_{τ = - ( M - 1 )}^{M - 1} {R}_{Er}^{2} ( τ ) \qquad ( 4 )$$

where the range of the summation in the denominator is 2M−1 where M is the number of training sequence Iₜᵣ(n) symbols. At step 310, ratio Q is compared with a threshold Thr. Ratio Q is high for the white noise component and is low for the non-white noise component. If ratio Q is greater than threshold Thr value, the white noise component is selected as the dominant noise component at step 312. However, if ratio Q is less than threshold Thr value, the non-white noise component is selected as the dominant noise component at step 314. The appropriate value of threshold Thr depends on the extent of co-channel interference experienced. Threshold Thr is different for different implementations. According to one embodiment of the disclosed invention, threshold Thr is determined experimentally for each implementation.

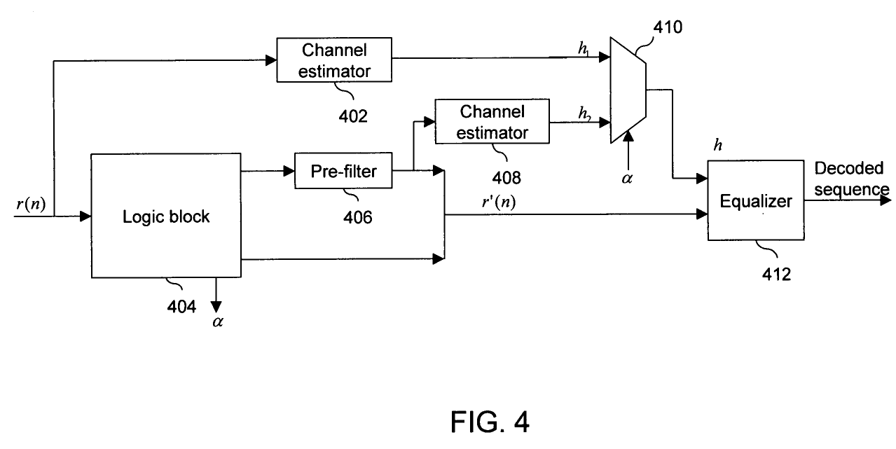

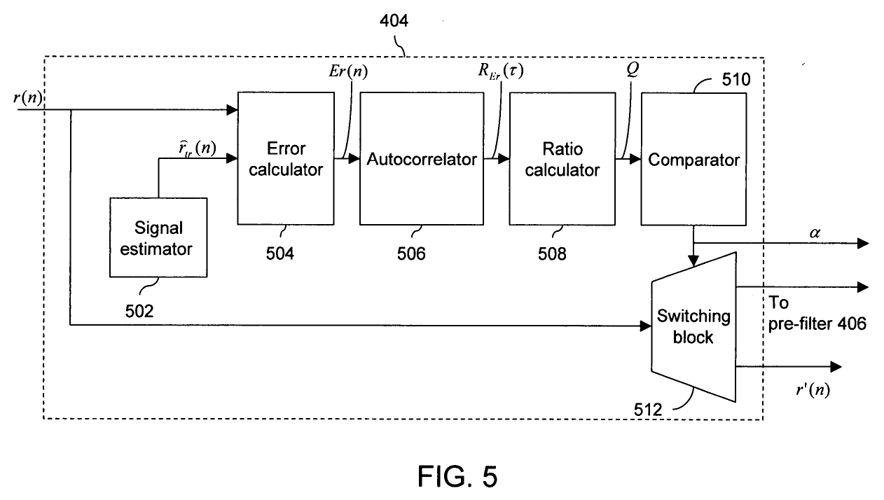

Referring primarily to FIG. 4, an apparatus for improving equalization in a wireless receiver, in accordance with an embodiment of the disclosed invention, is hereinafter described. The figure shows a channel estimator 402 used to obtain first channel estimate h₁ using received signal r(n) and training sequence Iₜᵣ(n). Received signal r(n) is also fed to a logic block 404. Logic block 404 identifies the dominant noise component in received signal r(n), and switches received signal r(n) on this basis. Further, logic block 404 generates a dominant noise component identifier a to indicate the dominant noise component identified in received signal r(n). Logic block 404, in accordance with an embodiment of the disclosed invention, is further described with reference to FIG. 5. If the non-white noise component dominates, logic block 404 switches received signal r(n) to a pre-filter 406. Pre-filter 406 whitens the non-white noise component in received signal r(n) and produces selectively filtered signal r′(n). Further, selectively filtered signal r′(n) is fed to a channel estimator 408 to obtain second channel estimate h₂, if the non-white component dominates. Second channel estimate h₂ includes the effect of pre-filter 406 on selectively filtered signal r′(n) in addition to the effect of the transmission channel. However, if the white noise component dominates, received signal r(n) is directly selected as selectively filtered signal r′(n). The appropriate channel estimate to be used to equalize selectively filtered signal r′(n), that is channel estimate h, is selected by a channel switch 410 using dominant noise component identifier a. First channel estimate hi is selected as channel estimate h if dominant noise component identifier a indicates that the white noise component is dominant. Second channel estimate h₂ is selected as channel estimate h if dominant noise component identifier a indicates that the non-white noise component is dominant. According to one embodiment of the disclosed invention, channel switch 410 is implemented using a multiplexer. Finally, selectively filtered signal r′(n) and channel estimate h are fed to an equalizer 412 for decoding. In an embodiment of the disclosed invention, equalizer 412 is a Maximum Likelihood Sequence Estimator (MLSE).

Referring primarily to FIG. 5, a logic block, in accordance with an embodiment of the disclosed invention, is hereinafter described. Logic block 404 determines the dominant noise component in received signal r(n) using training sequence Iₜᵣ(n), which is present in the desired signal, as follows: A signal estimator 502 in logic block 404 generates estimated received signal \hat{r}ₜᵣ(n) corresponding to training sequence Iₜᵣ(n), using training sequence Iₜᵣ(n) and estimate of channel impulse response ĥ(n). Received signal r(n), along with estimated received signal \hat{r}ₜᵣ(n), is fed to an error calculator 504. Error calculator 504 calculates error sequence Er(n) by subtracting received signal r(n) from estimated received signal \hat{r}ₜᵣ(n). Error sequence Er(n) is subsequently fed to an autocorrelator 506. Autocorrelator 506 computes autocorrelation function R_{Er}(τ) for error sequence Er(n). Squared autocorrelation function R_{Er}(r) is fed to a ratio calculator 508. Ratio calculator 508 computes ratio Q of the peak of squared autocorrelation function R_{Er}(τ) to the sum of squared autocorrelation function R_{Er}(τ) values. Ratio Q is passed to a comparator 510. Comparator 510 compares ratio Q with threshold Thr and produces dominant noise component identifier a. If ratio Q is greater than threshold Thr value, the white noise component is identified as dominant and dominant noise component identifier a is set accordingly. On the other hand, if ratio Q is less than threshold Thr, the non-white noise component is identified as dominant and dominant noise component identifier a is set accordingly. Further, a switching block 512 is used to switch received signal r(n) to either pre-filter 406, or directly to the connection representing selectively filtered signal r′(n) using dominant noise component identifier α. In one embodiment of the disclosed invention, switching block 512 is implemented using a demultiplexer.

In an exemplary embodiment, pre-filter 406 is a high-pass filter when the non-white noise is due to co-channel interference by GMSK signals in Global System for Mobile Communications (GSM) systems. The co-channel interference caused by the GMSK signal is non-white due to the effect of a Gaussian Low Pass Filter (GLPF) used in the GMSK signal modulation. The high pass filter compensates for the effect of the GLPF, thereby restoring the magnitude part of the MSK spectrum of the co-channel interference signal.

The disclosed invention may be implemented using a dedicated Application Specific Integrated Circuit (ASIC). Alternately, it may be implemented using a Digital Signal Processor (DSP) chip or a Field Programmable Gate Array (FPGA). It will be apparent to anyone skilled in the art that the disclosed invention may also be embodied in a computer program product using either a processor specific assembly language or a high-level language such as C. The computer program product embodiment of the disclosed invention can be used for either improving equalization in the wireless receiver, or for whitening the non-white noise component in the received signal.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

1. A method of improving equalization of a received signal in a wireless receiver, the received signal comprising a desired signal and noise, the desired signal comprising a training sequence known to the wireless receiver, the noise comprising a white noise component and a non-white noise component, the wireless receiver having knowledge of a first channel estimate, the method comprising the steps of:
a. determining a dominant noise component in the received signal;
b. pre-filtering the received signal to obtain a selectively filtered signal, if the dominant noise component is the non-white noise component;
c. obtaining a second channel estimate using the selectively filtered signal and the training sequence known to the wireless receiver, if the dominant noise component is the non-white noise component;
d. selecting the received signal as the selectively filtered signal, if the dominant noise component is the white noise component;
e. equalizing the selectively filtered signal using the first channel estimate, if the dominant noise component is the white noise component; and
f. equalizing the selectively filtered signal using the second channel estimate, if the dominant noise component is the non-white noise component.

2. The method as recited in claim 1 wherein determining the dominant noise component in the received signal comprises the steps of:
a. generating an estimated received signal corresponding to the training sequence;
b. calculating an error sequence using the received signal and the estimated received signal;
c. computing an autocorrelation function for the error sequence;
d. computing a ratio of peak of the squared autocorrelation function to the sum of the squared autocorrelation function values;
e. declaring white noise component as the dominant noise component, if the ratio is greater than a threshold; and
f. declaring non-white noise component as the dominant noise component, if the ratio is less than the threshold.

3. The method as recited in claim 1 wherein the equalizing step is carried out by an MLSE.

4. The method as recited in claim 1 wherein the non-white noise component comprises co-channel interference.

5. The method as recited in claim 1 wherein the wireless receiver is a GMSK receiver.

6. The method as recited in claim 1 wherein the method is embodied in a computer program product.

7. A method of whitening a received signal, the received signal comprising a desired signal and noise, the desired signal comprising a training sequence known to the wireless receiver, the noise comprising a white noise component and a non-white noise component, the method comprising the steps of:
a. determining a dominant noise component in the received signal; and
b. pre-filtering the received signal to generate a selectively filtered signal, if the dominant noise component is the non-white noise component.

8. The method as recited in claim 6 wherein the step of determining the dominant noise component in the received signal comprises the steps of:
a. generating an estimated received signal corresponding to the training sequence;
b. calculating an error sequence using the received signal and the estimated received signal;
c. computing an autocorrelation function for the error sequence;
d. computing a ratio of peak of the squared autocorrelation function to the sum of the squared autocorrelation function values;
e. declaring white noise component as the dominant noise component, if the ratio is greater than a threshold; and
f. declaring non-white noise component as the dominant noise component, if the ratio is less than the threshold.

9. The method as recited in claim 6 wherein the non-white noise component comprises co-channel interference.

10. The method as recited in claim 6 wherein the method is embodied in a computer program product.

11. An apparatus for improving equalization in a wireless receiver, the wireless receiver processing a received signal, the received signal comprising a desired signal and noise, the desired signal comprising a training sequence known to the wireless receiver, the noise comprising a white noise component and a non-white noise component, the apparatus comprising:
a. a logic block, the logic block determining a dominant noise component in the received signal;
b. a pre-filter, the pre-filter generating a selectively filtered signal based on the determined dominant noise component;
c. a channel estimator, the channel estimator generating a channel estimate using a channel impaired training sequence and the training sequence known to the wireless receiver; and
d. an equalizer, the equalizer equalizing the selectively filtered signal using the channel estimate.

12. The apparatus as recited in claim 9 wherein the logic block comprises:
a. a signal estimator, the signal estimator generating an estimated received signal corresponding to the training sequence;
b. an error calculator, the error calculator calculating an error sequence using the received signal and the estimated received signal;
c. an autocorrelator, the autocorrelator computing an autocorrelation function for the error sequence;
d. a ratio calculator, the ratio calculator computing a ratio of peak of the squared autocorrelation function to the sum of the squared autocorrelation function values; and
e. a switching block, the switching block comparing the ratio with a threshold to determine the dominant noise component.

13. The apparatus as recited in claim 9 wherein the equalizer is an MLSE.

14. An apparatus for whitening a received signal, the received signal comprising a desired signal and noise, the desired signal comprising a training sequence known to the wireless receiver, the noise comprising a white component and a non-white component, the apparatus comprising:
a. a logic block, the logic block determining a dominant noise component in the received signal; and
b. a pre-filter, the pre-filter generating a selectively filtered signal based on the determined dominant noise component.

15. The apparatus as recited in claim 12 wherein the logic block determining the dominant noise component in the received signal comprises:
a. a signal estimator, the signal estimator generating an estimated received signal corresponding to the training sequence;
b. an error calculator, the error calculator calculating an error sequence using the received signal and the estimated received signal;
c. an autocorrelator, the autocorrelator computing an autocorrelation function for the error sequence;
d. a ratio calculator, the ratio calculator computing a ratio of peak of the squared autocorrelation function to the sum of the squared autocorrelation function values; and
e. a switching block, the switching block comparing the ratio with a threshold to determine the dominant noise component.

16. The apparatus as recited in claim 12 wherein the pre-filter is a high pass filter.

17. The apparatus as recited in claim 12 wherein the non-white component comprises co-channel interference.
